(19) United States
(12) Patent Application Publication
(10) Pub. No.: US 2009/0007823 A1
(43) Pub. Date: Jan. 8, 2009

(54) Work table with leveling screws

(76) Inventor: Ben Yu, Taichung (TW)

Correspondence Address: CHARLES E. BAXLEY, ESQUIRE, 90 JOHN STREET, SUITE 309, NEW YORK, NY, 10038, US

(21) Appl. No.: 11/825,349

(22) Filed: Jul. 6, 2007

(51) Int. Cl. B25H 1/14

(52) U.S. Cl. 108/33

(57) ABSTRACT

A work table includes a housing for supporting a working machine and having four corner areas, four leveling screws adjustably threaded to the corner areas of the housing, four lock nuts engaged with the leveling screws for selectively securing the leveling screws to the housing, four foot members attached to the leveling screws for stably engaging with a supporting surface, and four wheel devices attached to each of the corner areas of the housing for selectively engaging with the supporting surface, either of the foot members may be adjusted higher or lower than the wheel devices for allowing the housing to be moved to any required positions or to be stably supported on the supporting surface.

### BACKGROUND OF THE INVENTION

1. Field of the Invention

The present invention relates to a work table or a machine tool or a working machine, and more particularly to a work table including an adjustable supporting device for allowing the work table to be easily moved and to be stably supported on the ground or the supporting surface and to be suitably adjusted or leveled.

2. Description of the Prior Art

Typical work tables comprise a table body for supporting various machine tools or working machines, and for supporting various work pieces to be machined or operated or worked by the machine tools or working machines.

For example, U.S. Pat. No. 5,535,766 to Edwards discloses one of the typical transmission service benches comprising two wheels attached to one side of a table body, and two leveling screws attached to the other side of the table body, and a caster and a caster wheel provided in the middle portion of the table body for allowing the caster wheel and the wheels to support the weight of the service bench.

However, the caster and the caster wheel include a complicated structure that may increase the manufacturing cost of the service bench. In addition, the leveling screws may not stably support the service bench and will be engaged into the ground or will damage the floor.

U.S. Pat. No. 6,508,281 to Wang discloses another typical work table comprising four leveling screws attached to the corner areas of the table body for leveling purposes.

However, the typical work tables do not have wheels or caster wheels such that the typical work table may not be easily moved to the other places particularly when heavy machine tools or working machines are supported on the table body.

The present invention has arisen to mitigate and/or obviate the afore-described disadvantages of the conventional leveling devices for the work tables.

### SUMMARY OF THE INVENTION

The primary objective of the present invention is to provide a work table including an adjustable supporting device for allowing the work table to be easily moved and to be stably supported on the ground or the supporting surface and to be suitably adjusted or leveled.

In accordance with one aspect of the invention, there is provided a work table comprising a housing for supporting a working machine thereon, the housing including a bottom portion having four corner areas, four leveling screws threaded and engaged with the corner areas of the housing respectively and adjustable relative to the housing, four lock nuts attached and engaged with the leveling screws respectively for engaging with the housing and for selectively securing the leveling screws to the housing at a selected position, four foot members attached to bottom of the leveling screws respectively, and the foot members each including a diameter greater than that of the leveling screw for stably engaging with a supporting surface and for stably supporting either of the corner areas of the housing on the supporting surface, and four wheel devices attached to each of the corner areas of the housing and disposed beside the leveling screws respectively, and each including a wheel member for selectively engaging with the supporting surface, either of the foot members of the leveling screws being selectively adjustable higher than bottom of the wheel member for allowing the wheel member to be engaged with the supporting surface and for allowing the housing to be moved to any required positions, the foot members of the leveling screws being selectively adjustable lower than bottom of the wheel members for elevating the wheel members and for separating the wheel members from the supporting surface and for stably supporting the housing on the supporting surface, and either of the foot members of the leveling screws being selectively adjustable relative to the wheel devices and the supporting surface for leveling the housing and for preventing the housing from being tilted relative to the supporting surface.

The housing includes four plates attached to the corner areas respectively for attaching the leveling screws and the wheel devices respectively.

The plates each include an orifice formed therein for engaging with the leveling screw and for allowing the leveling screw to be rotated and adjusted relative to the plate of the housing. The plates each include a fixed nut aligned with the orifice of the plate for threading with the leveling screw.

The wheel devices each include a base secured to the plate and each include two flaps extended downwardly therefrom for rotatably attaching the wheel member with an axle.

The leveling screws each include an enlarged head formed in bottom for attaching the foot members. The leveling screws each include a screw hole formed in the enlarged head for engaging with a fastener which secure the foot member to the enlarged head of the leveling screw.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a work table in accordance with the present invention;

FIG. 2 is a partial bottom perspective view illustrating the adjustable supporting device of the work table;

FIG. 3 is a partial exploded view of the adjustable supporting device of the work table;

FIG. 4 is a partial cross sectional view of the work table taken along lines 4-4 of FIG. 1;

FIG. 5 is an enlarged partial cross sectional view of the work table as shown in FIG. 4;

FIGS. 6, 7 are partial cross sectional views similar to FIG. 4, illustrating the operation of the work table; and

FIG. 8 is an enlarged partial cross sectional view of the work table as shown in FIG. 7.

### DETAILED DESCRIPTION OF THE PREFERRED EMBODIMENT

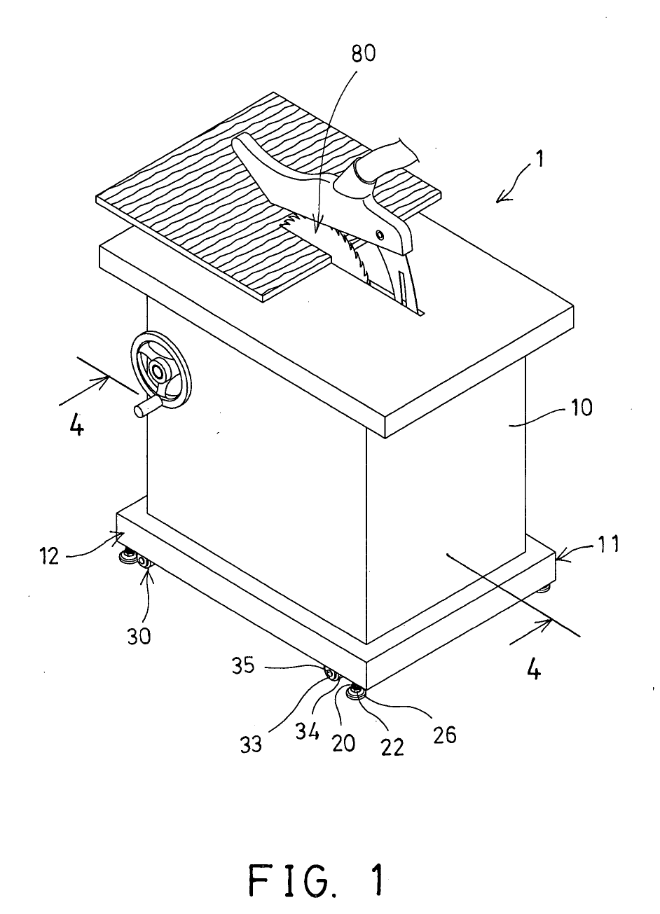

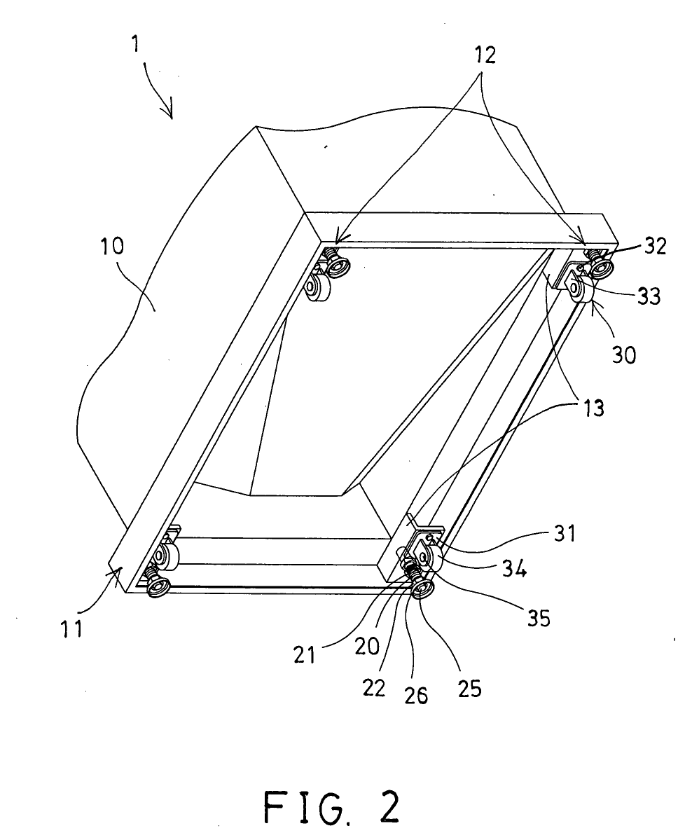

Referring to the drawings, and initially to FIGS. 1-4, a work table 1 in accordance with the present invention comprises a table body or housing 10 for supporting a machine tool or working machine 80 thereon, and including a bottom portion 11 having four corner areas 12, and four angles or plates 13 attached to the corner areas 12 respectively, the plates 13 each include an orifice 14 formed therein for engaging with a leveling screw 20, and a fixed nut 15 attached or secured onto each of the plates 13 and aligned with the respective orifice 14 thereof for threading with the leveling screw 20 and for allowing the leveling screw 20 to be rotated and adjusted relative to the plate 13 of the housing 10.

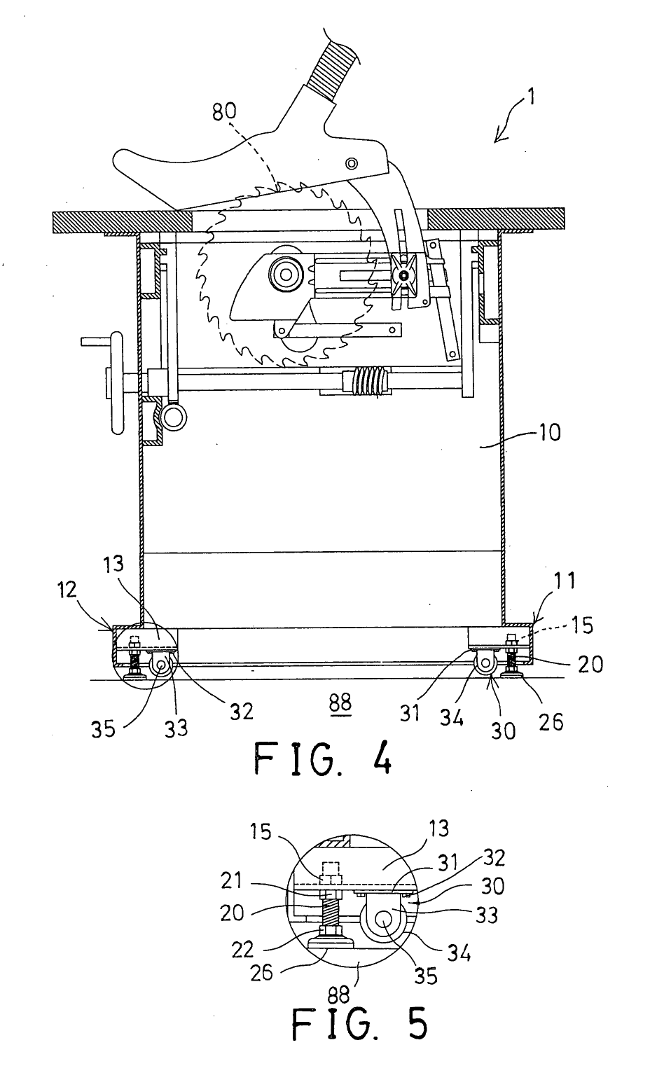

A lock nut 21 may further be provided and attached to or engaged with each of the leveling screws 20 for engaging with the plates 13 of the housing 10 and for selectively and solidly securing the leveling screws 20 to the plates 13 of the housing 10 at the predetermined or selected position or location, and for allowing the leveling screws 20 to be rotated relative to the plates 13 of the housing 10 (FIGS. 4-8) before the lock nut 21 secures the leveling screw 20 to the plate 13 of the housing 10. The leveling screws 20 each include an enlarged head 22 formed in the lower or bottom portion 23 thereof, and a screw hole 24 formed in the lower or bottom portion 23 of the leveling screw 20 for engaging with a fastener 25. It is preferable that the head 22 includes a non-circular cross section for allowing the head 22 or the leveling screw 20 to be rotated or driven by driving tools, such as wrenches or the like.

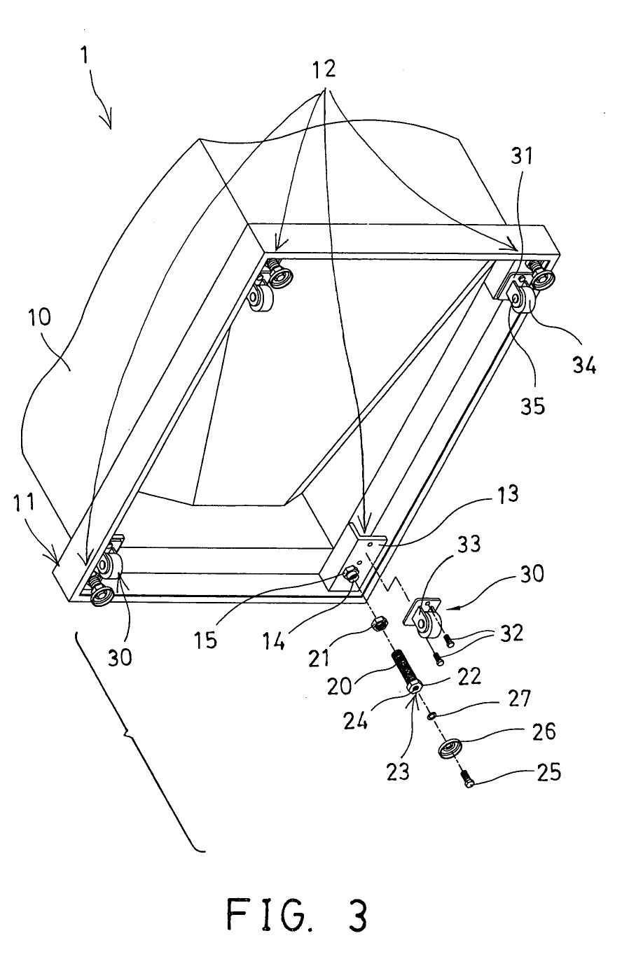

For example, a foot member 26 may be attached or secured to the lower or bottom portion 23 of each of the leveling screws 20 with the fastener 25, and includes an enlarged or greater outer diameter than that of the leveling screw 20 and/or the enlarged head 22 for providing an increased contact area with the supporting surface or the ground or the floor 88 and for stably supporting either of the corner areas 12 of the housing 10 on the supporting surface or the ground or the floor 88. One or more washers 27 (FIG. 3) may further be provided for engaging onto the fastener 25, and/or for engaging between the fastener 25 and the leveling screw 20 and the foot member 26.

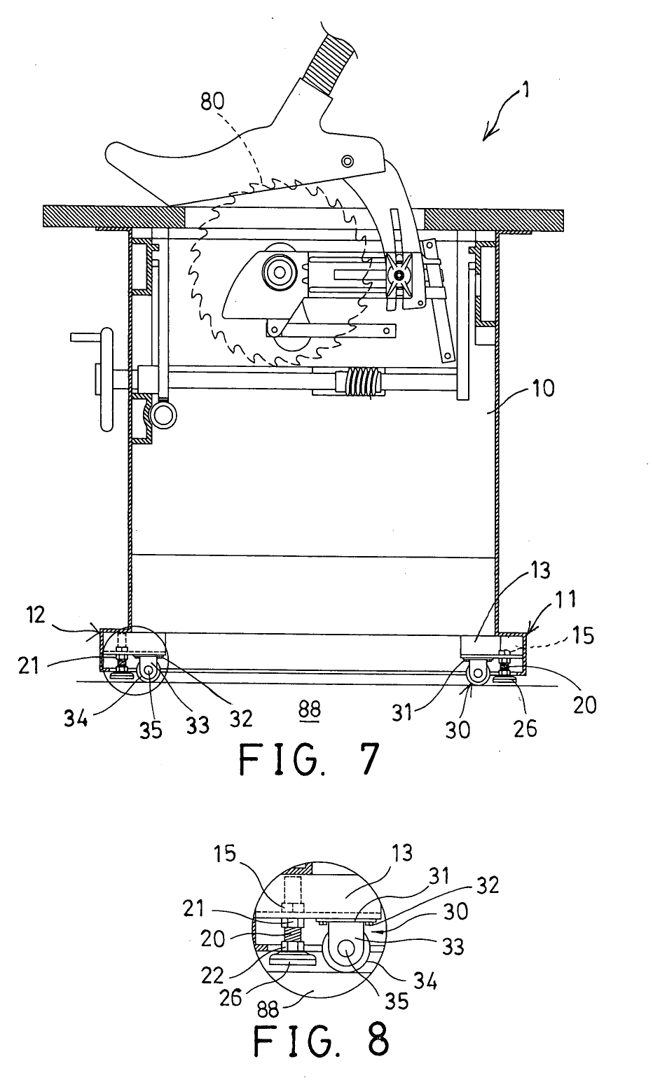

A caster wheel or wheel device 30 is further provided and attached or engaged onto each of the plates 13 or onto each of the corner areas 12 of the housing 10 and disposed beside the leveling screw 20 respectively for selectively engaging with the supporting surface or the ground or the floor 88 (FIGS. 7, 8) and for allowing the housing 10 and the heavy machine tool or working machine 80 to be easily moved to the other predetermined or selected or required positions or locations. The wheel devices 30 each include a base or base panel 31 secured to the plate 13 or secured to each of the corner areas 12 of the housing 10 with one or more fasteners 32, and each include two flaps 33 extended downwardly therefrom for attaching a wheel member 34.

For example, the wheel member 34 is rotatably engaged between the flaps 33 of each of the wheel devices 30 and rotatably attached or secured to the flaps 33 with an axle 35 for allowing the wheel devices 30 to be rotatably attached or secured to the plate 13 or to each of the corner areas 12 of the housing 10 and for allowing the wheel devices 30 to be selectively engaged with the supporting surface or the ground or the floor 88 (FIGS. 7, 8) when required, and when the foot member 26 is moved or adjusted higher than the bottom of the wheel member 34.

In operation, as shown in FIGS. 4, 5, the foot members 26 may be selectively moved or adjusted lower than the bottom of the wheel members 34 for elevating the wheel members 34 and for separating the wheel members 34 from the supporting surface or the ground or the floor 88, and thus for stably supporting the housing 10 and the heavy machine tool or working machine 80 on the supporting surface or the ground or the floor 88, and thus for allowing the machine tool or working machine 80 to be safely and effectively operated by the users.

As shown in FIGS. 7, 8, the foot members 26 may also be selectively moved or adjusted higher than the bottom of the wheel members 34 for allowing the wheel members 34 to be contacted or engaged with the supporting surface or the ground or the floor 88, and thus for allowing the housing 10 and the heavy machine tool or working machine 80 to be easily moved to the other predetermined or selected or required positions or locations when required.

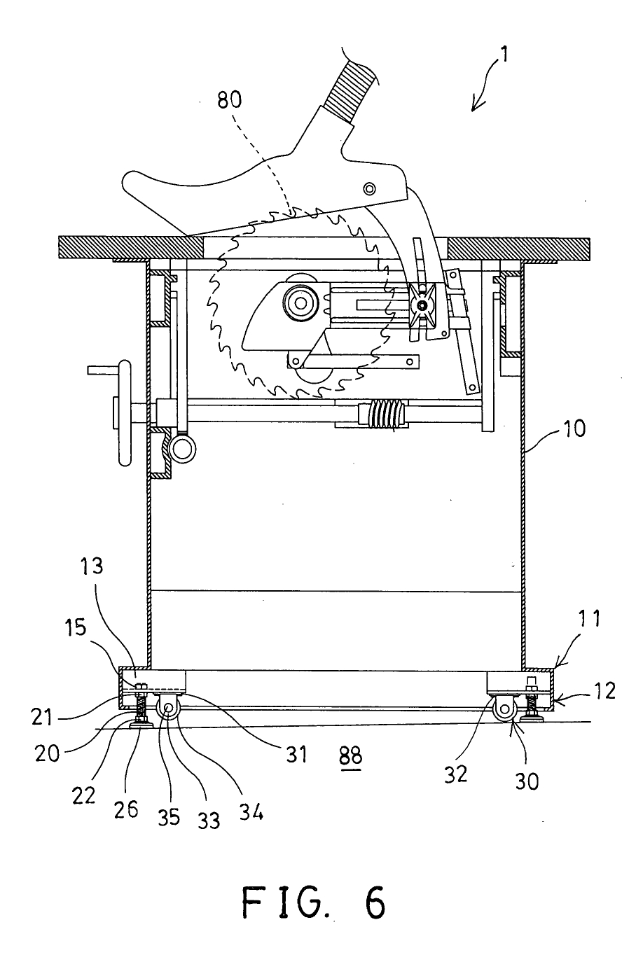

As shown in FIG. 6, either of the foot members 26 may be selectively moved or adjusted relative to the wheel devices 30 and/or the supporting surface or the ground or the floor 88, for suitably leveling the housing 10 and the machine tool or working machine 80 and for preventing the housing 10 and the machine tool or working machine 80 from being tilted relative to the supporting surface or the ground or the floor 88.

It is to be noted that the housing 10 includes four leveling screws 20 and four wheel devices 30 attached or secured to the plates 13 or to the corner areas 12 of the housing 10 respectively, for allowing either of the foot members 26 or either of the leveling screws 20 to be selectively moved or adjusted relative to the wheel devices 30 and/or the supporting surface or the ground or the floor 88, and for allowing either of the corner areas 12 of the housing 10 to be suitably leveled.

Accordingly, the work table in accordance with the present invention includes an adjustable supporting device for allowing the work table to be easily moved and to be stably supported on the ground or the supporting surface and to be suitably adjusted or leveled.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A work table comprising:
a housing for supporting a working machine thereon, said housing including a bottom portion having four corner areas,
four leveling screws threaded and engaged with said corner areas of said housing respectively and adjustable relative to said housing,
four lock nuts attached and engaged with said leveling screws respectively for engaging with said housing and for selectively securing said leveling screws to said housing at a selected position,
four foot members attached to bottom of said leveling screws respectively, and said foot members each including a diameter greater than that of said leveling screw for stably engaging with a supporting surface and for stably supporting either of said corner areas of said housing on said supporting surface, and
four wheel devices attached to each of said corner areas of said housing and disposed beside said leveling screws respectively, and each including a wheel member for selectively engaging with said supporting surface,
either of said foot members of said leveling screws being selectively adjustable higher than bottom of said wheel member for allowing said wheel member to be engaged with said supporting surface and for allowing said housing to be moved to any required positions, said foot members of said leveling screws being selectively adjustable lower than bottom of said wheel members for elevating said wheel members and for separating said wheel members from said supporting surface and for stably supporting said housing on said supporting surface, and either of said foot members of said leveling screws being selectively adjustable relative to said wheel devices and said supporting surface for leveling said housing and for preventing said housing from being tilted relative to said supporting surface.

2. The work table as claimed in claim 1, wherein said housing includes four plates attached to said corner areas respectively for attaching said leveling screws and said wheel devices respectively.

3. The work table as claimed in claim 2, wherein said plates each include an orifice formed therein for engaging with said leveling screw and for allowing said leveling screw to be rotated and adjusted relative to said plate of said housing.

4. The work table as claimed in claim 3, wherein said plates each include a fixed nut aligned with said orifice of said plate for threading with said leveling screw.

5. The work table as claimed in claim 2, wherein said wheel devices each include a base secured to said plate and each include two flaps extended downwardly therefrom for rotatably attaching said wheel member with an axle.

6. The work table as claimed in claim 1, wherein said leveling screws each include an enlarged head formed in bottom for attaching said foot members.

7. The work table as claimed in claim 6, wherein said leveling screws each include a screw hole formed in said enlarged head for engaging with a fastener which secure said foot member to said enlarged head of said leveling screw.
